(19) United States
(12) Patent Application Publication
(10) Pub. No.: US 2008/0224448 A1
(43) Pub. Date: Sep. 18, 2008

(54) BALL MOUNT STORAGE DEVICE

(76) Inventors: Matthew Siemantel, Mooresville, IN (US); Alan W. Jones, Shelbyville, IN (US)

Correspondence Address: BARNES & THORNBURG LLP, 11 SOUTH MERIDIAN, INDIANAPOLIS, IN, 46204, US

(21) Appl. No.: 12/046,845

(22) Filed: Mar. 12, 2008

Related U.S. Application Data
(60) Provisional application No. 60/895,078, filed on Mar. 15, 2007.

(51) Int. Cl. B60D 1/60

(52) U.S. Cl. 280/507

(57) ABSTRACT

A storage device is configured to be coupled to the receiver of a tow vehicle. A ball mount, or tongue, may be stowed within a receptacle of the storage device when not in use.

This application claims priority under 35 U.S.C. §119(e) to U.S. Provisional Patent Application Ser. No. 60/895,078, filed Mar. 15, 2007 entitled BALL MOUNT STORAGE DEVICE, the entirely of which is hereby incorporated by reference herein.

### TECHNICAL FIELD

The present disclosure relates generally to tow bars mounted to the back of a tow vehicle. In particular, the present disclosure relates to a storage device coupled to the tow bar to stow a ball mount (or tongue) therein.

### BACKGROUND

A tow bar is a device attached to the back or rear end of a chassis of a tow vehicle for coupling items to be towed thereto. The tow bar generally includes a receiver for receiving a hitch, a receiver adapter, a ball mount (or tongue), as well as other various accessories therein. The tow bar may be an original component of the tow vehicle or may be added as an aftermarket component. Furthermore, the tow bar may form a permanent part of the tow vehicle or may be removably coupled to the tow vehicle as needed.

As noted above, a ball mount may be coupled to the tow bar in order to attach various items to be towed thereto. A ball mount generally includes a bar received within the receiver of the tow bar and a curved flange to which a tow ball is attached. When coupled to the tow bar, the ball mount extends outwardly away from the tow vehicle to protrude beyond the rear bumper of the tow vehicle. This may pose a nuisance to people walking around or near the tow vehicle who may trip on or run into the portion of the ball mount which protrudes beyond the rear bumper of the tow vehicle.

### SUMMARY

The present invention comprises one or more of the features recited in the appended claims or the following features or combinations thereof:

A storage device is configured to be coupled to a receiver of a tow vehicle and is configured to receive a ball mount in a stowed position therein. The storage device includes a storage receptacle and a mount coupled to the storage receptacle. The storage receptacle includes opposite side walls, a top wall, a bottom wall to define an inner cavity configured to receive a portion of the ball mount therein. An aperture is formed in each of the opposite side walls of the storage receptacle.

Illustratively, the longitudinal axis of the inner cavity of the storage receptacle is perpendicular to the longitudinal axis of an inner cavity of the receiver.

Further illustratively, the mount may include first and second studs coupled to the top wall of the storage receptacle in spaced-apart relationship to one another and an upper bracket removably coupled to each of the first and second studs. Alternatively, the mount may include first and second flanges coupled to the top wall of the storage receptacle in spaced-apart relationship to one another and a top wall coupled to each of the first and second flanges to define an aperture configured to receive the receiver therethrough.

According to another aspect of the present disclosure, a storage device configured to be coupled to a receiver of a tow vehicle includes a generally square-shaped tube defining an inner cavity configured to receive a portion of the ball mount therein. The longitudinal axis of the inner cavity of the tube is perpendicular to the longitudinal axis of an inner cavity of the receiver. The storage device further includes a mount coupled to a top wall of the tube and configured to be removably coupled to the receiver.

According to yet another aspect of the present invention, a method of storing a ball mount in a stowed position on a tow vehicle includes coupling a generally square-shaped tube to a receiver of the tow vehicle, positioning the tube below the receiver such that the longitudinal axis of the tube is generally perpendicular to the longitudinal axis of the receiver, and inserting a portion of the ball mount within the tube. The ball mount may further be locked to the tube.

The above and other features of the present disclosure will become apparent from the following description and the attached drawings.

### BRIEF DESCRIPTION OF THE DRAWINGS

The detailed description particularly refers to the following figures, in which:

FIG. 1 is a rear view of a tow vehicle showing a receiver of a tow bar of the vehicle;

FIG. 2 is a side, perspective view of the tow vehicle of FIG. 1 showing a ball mount coupled to the receiver;

FIG. 3 is a rear view of the tow vehicle of FIGS. 1 and 2 showing the ball mount stowed in a storage device coupled to the receiver;

FIG. 4 is a front view of the storage device shown in FIGS. 1-3;

FIG. 5 is a side view of the storage device shown in FIGS. 1-4;

FIG. 6 is a front view of an alternative storage device;

FIG. 7 is a side view of the storage device of FIG. 6; and

FIG. 8 is a front view of another storage device.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

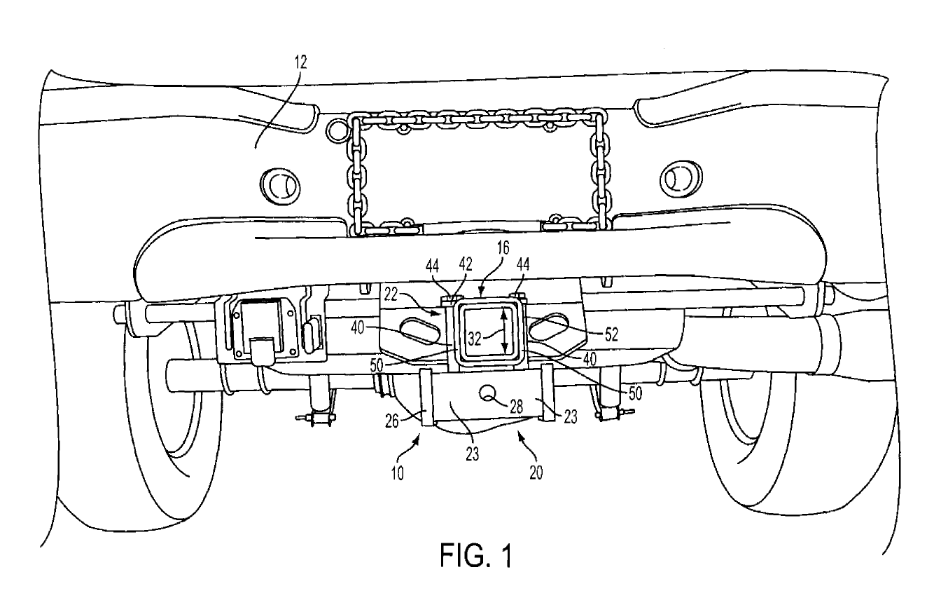

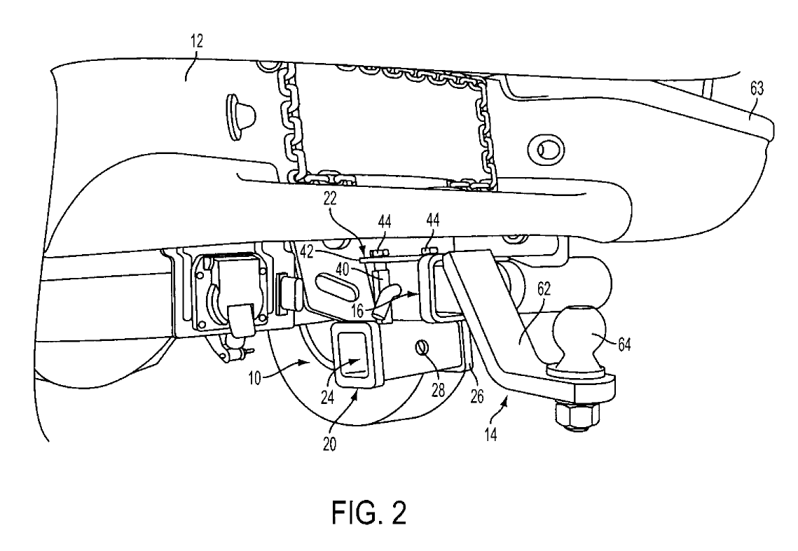

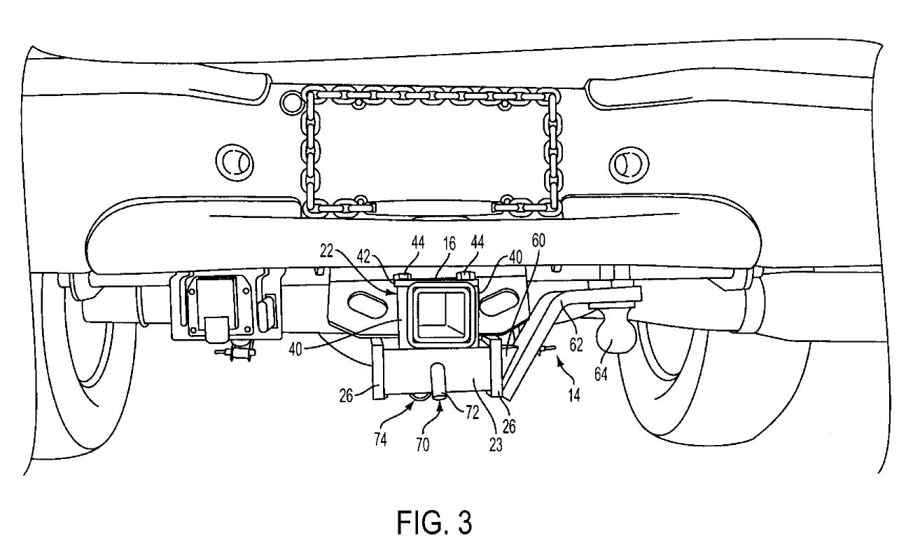

Looking first to FIGS. 1-3, a storage device 10 is coupled to a tow vehicle, such as a truck 12, to stow a ball mount, or tongue, 14 therein. In particular, the storage device 10 is coupled to a receiver 16 of the vehicle 12. Illustratively, as is discussed in greater detail below, the ball mount 14 may be coupled to the receiver 16 in a use position, as shown in FIG. 2, and may be coupled to the storage device 10 in a stowed position, as shown in FIG. 3.

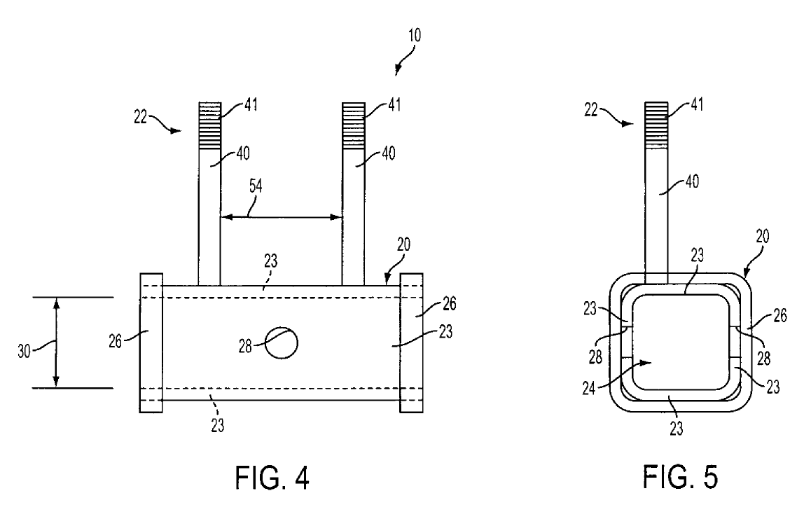

The storage device 10 includes a square-shaped tube or receptacle 20 and a mount 22 coupled to the receptacle 20. In particular, the receptacle 20 includes four outer walls 23 defining a cavity 24 configured to receive the ball mount 14 and first and second collar 26 coupled the outer ends of each of the four walls 23, as shown in FIGS. 4 and 5. An aperture 28 is formed in two side walls of the four outer walls 23, as shown in FIG. 5. Illustratively, the two side walls 23 into which the aperture is formed are parallel to and spaced-apart from each other. As further shown in FIG. 5, the receptacle 20 is generally square-shaped when viewed from an end. Illustratively, an inner height and/or width 30 of the square-shaped cavity 24 is the same as or similar to an inner height and/or width 32 of an inner cavity of the square-shaped receiver 16.

The mount 22 of the illustrative storage device 10 includes first and second studs 40 coupled to the top wall 23 of the receptacle 20 in a spaced-apart relationship to one another. Illustratively, each stud 40 includes a threaded end 41, as shown in FIGS. 4 and 5. The first and second studs 40 are illustratively tig welded to the top wall 23 of the receptacle 20. However, it is within the scope of this disclosure to couple the studs 40 to the receptacle 20 using other welding techniques as well as a fastener such as a pin, bolt, screw, etc. Illustratively, the mount 22 further includes an upper plate 42, shown in FIGS. 1 and 3, coupled to and extending between each of the first and second studs 40. Two nuts 44 are used to removably couple the upper plate 42 to each of the studs 40. Illustratively, the threaded end 41 of each stud 40 is received through an aperture (not shown) of the plate 42 and the nuts 44 are then threaded into the respective ends 41 in order to secure the plate 42 to the studs 40.

In use, the storage device 10 is coupled to the receiver 16 of the tow vehicle 12 such that the receptacle 20 of the device 10 is positioned below the receiver 16, as shown in FIGS. 1-3, for example. Illustratively, the longitudinal axis of the cavity 24 of the receptacle is generally perpendicular to the longitudinal axis of the cavity of the receiver 16 such that the ball mount 14 stowed within the cavity 24 in an out-of-the way position, as shown in FIG. 3. In order to couple the storage device 10 to the receiver 16, the receptacle 20 is positioned below the receiver 16 such that each of the first and second studs 40 is adjacent to an outer side wall 50 of the receptacle 16 and positioned generally behind (or in a direction toward the tow vehicle 12) an outer collar 52 of the receiver 16. Once the receptacle 20 and studs 40 are properly positioned on the receiver 16, the upper plate 42 is then positioned adjacent the top wall 50 of the receiver 16 and the nuts 44 are screwed onto the threaded ends 41 of each stud 40 in order to secure the upper plate 42 to the studs 40. As shown in FIGS. 1-3, the outer collar 52 of the receiver 16 operates as a stop to prevent the storage device 10 from falling off of or being unintentionally removed from the receiver 16.

Illustratively, the distance 54 between the mount studs 40 is the same as or similar to the distance (not shown) between the outer surface of the outer side walls 50 of the receiver 16. However, it is within the scope of this disclosure to space the studs 40 any suitable distance apart from each other for mounting to any-sized tow bar receiver.

As noted above, the storage device 10 operates to stow the ball mount 14 therein when the ball mount 14 is not in use, as shown in FIG. 3. Illustratively, the ball mount 14 includes a bar 60 (shown in FIG. 3) configured to be received within the receiver 16 and a curved flange 62 coupled to one end of the bar 60. A tow ball 64 is attached to the outer end of the curved flange 62. Looking now to FIG. 2, the ball mount 14 is in the use position such that the bar 60 of the ball mount 14 is received within the receiver 16. In the use position, the flange 62 of the ball mount 14 extends outwardy in a direction away from the tow vehicle 12 and the receiver 16 and illustratively protrudes beyond the bumper 63 of the tow vehicle 12.

Illustratively, when not in use, the ball mount 14 may be stowed in an out-of-the-way location within the storage device 10, as shown in FIG. 3. In particular, the bar 60 of the ball mount 14 is received within the cavity 24 of the receptacle 20. Illustratively, the bar 60 of the ball mount 14 may be received within either end of the receptacle 20. The ball mount 14 is then secured to the receptacle 20 by a fastener or locking pin 70 inserted through the apertures 28 formed in the opposite side walls 23 of the receptacle 20 as well as through corresponding apertures (not shown) formed in opposite side walls of the bar 60 of the ball mount 14. Illustratively, the fastener 70 includes a handle 72 coupled to an elongated body (not shown) received through the outer walls of the receptacle 20 and the receiver 16. A cotter pin 74, or other such securing device, is received through an aperture formed in the body of the fastener 70 in order to prevent the fastener 70 from unintentionally being removed from the apertures 28 of the receptacle 20. Accordingly, the ball mount 14 is secured within the cavity 24 of the storage device 10 in a stowed or out-of-the-way position. Illustratively, while the locking pin 70 is shown and described above, it is within the scope of this disclosure to alternatively provide a commercially-available barbell lock (not shown) for securing the ball mount 14 within the cavity 24 of the device 10. Further illustratively, while the locking pin 70 or the barbell lock may be used to secure the ball mount 14 within the device 10, the locking pin 70 or barbell lock may also be used to secure the ball mount 14 within the receiver 16. In other words, the same fastener may be used to secure the ball mount 14 within the receiver 16 as well as within the tube 20 of the storage device 10. Alternatively, separate fasteners may be provided.

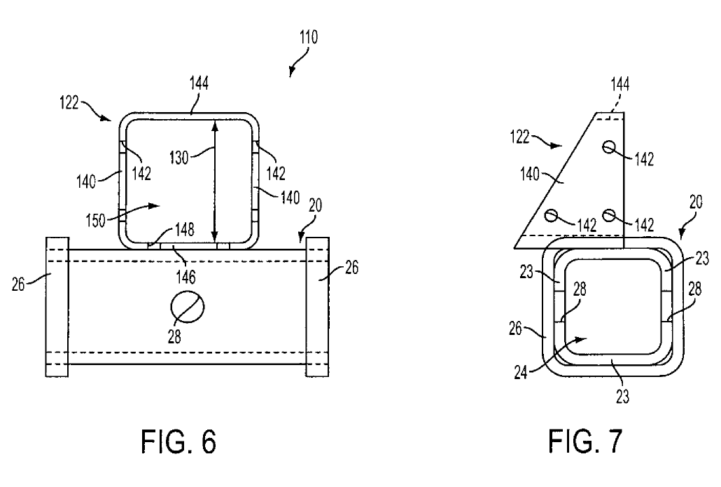

Looking now to FIGS. 6 and 7, an alternative storage device 110 includes the tube or receptacle 20 and an alternative mount 122 coupled to the receptacle 20. Illustratively, the mount 122 includes first and second side flanges 140 coupled to the top wall 23 of the receptacle 20 in a spaced-apart relationship to each other. Each flange 140 is generally triangular in shape and includes three apertures 142 formed therein. A top and bottom wall 144, 146 of the mount 122 are each positioned between and coupled to the side flanges 140 to define a generally square-shaped aperture 150 configured to receive the receiver 16 therethrough. Illustratively, the bottom wall 146 is adjacent the top wall 23 of the receptacle 20 and includes two apertures 148 formed therein. The apertures 148 may receive a fastener such as a bolt or pin (not shown) in order to couple the bottom wall 146 to the receptacle 20. Alternatively, the bottom wall 146 of the mount 122 may be welded to the top wall 23 of the receptacle 20.

Illustratively, the mount 122 is generally square-shaped when viewed from the front, as shown in FIG. 6, and defines an inner height and/or width 130 (i.e., the width of the aperture 150) greater than the outer height and/or width (not shown) of the square-shaped receiver 16. In particular, the inner height and/or width 130 of the mount 122 is greater than the outer height and/or width (not shown) of the collar 26 of the receiver 16 such that the receiver 16 is able to be received through the aperture 150 of the mount 122. In other words, the mount 122 may be placed over the collar 26 and onto the body of the receiver 16 in a position generally behind the collar 26. The storage device 110 is secured to the receiver 16 through the use of set screws (not shown) which may be inserted into the apertures 148 of the side flanges 140 of the mount 122 to engage the corresponding side walls of the receiver 16. Illustratively, therefore, the apertures 142 of the flanges 140 may be threaded. Similar to that described above in regards to device 10, the ball mount 14 may be maintained in the stowed position within the storage device 110.

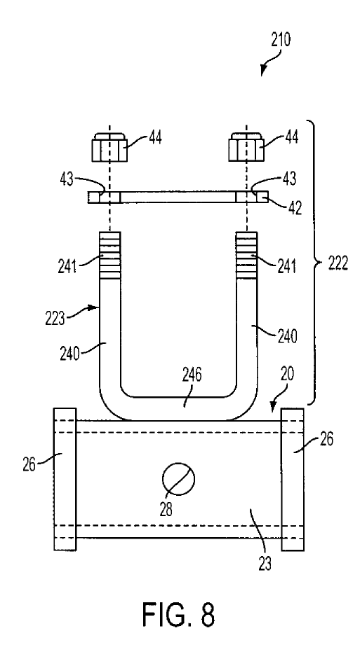

Looking now to FIG. 8, another storage device 210 includes the receptacle 20 and an alternative mount 222 coupled to the receptacle 20. The mount 222 is similar to the mount 22 shown in FIG. 4, which includes two spaced-apart studs 40, and includes a U-shaped bolt 223 having a pair of upright, parallel arms or stud portions 240 and a connecting portion 246 tig welded to the top wall 23 of the receptacle 20. The U-shaped bolt 223 may also be coupled to the receptacle using other welding techniques as well as a fastener such as a pin, bolt, screw, etc. In use, the U-shaped bolt 223 of the mount 222 is placed around the body of the receiver 16 in a position generally behind the collar 26 of the receiver 16. The upper plate 42 is then placed onto the studs 240 of the bolt 223 such that a threaded portion 241 of each stud 240 is received through the respective aperture 43 of the plate 42. The nuts 44 are then threaded onto the threaded portion 241 of each stud 240 in order to secure the plate 42 to the bolt 223. Similar to that described above in regards to devices 10, 110, the ball mount 14 may be maintained in the stowed position within the storage device 210.

Illustratively, while the ball mount 14 is shown and described for use with the storage devices 10, 110, 210, it is within the scope of this disclosure to configure the storage devices 10, 110, 210 for use with any suitable ball mount and/or other hitch-type mechanism normally configured to be received within a receiver of a particular tow vehicle. Furthermore, while the storage devices 10, 110, 210 described herein are secured to the illustrative receiver 16 as an aftermarket component, it is within the scope of this disclosure to include an OEM storage device either welded to the receiver or otherwise formed integrally (e.g., by casting) therewith.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the systems and methods described herein. It will be noted that alternative embodiments of the systems and methods of the present disclosure may not include all of the features described yet still benefit from at least some of the advantages of such features. Those of ordinary skill in the art may readily devise their own implementations of the systems and methods that incorporate one or more of the features of the present invention and fall within the spirit and scope of the present disclosure as defined by the appended claims.

1. A storage device configured to be coupled to a receiver of a tow vehicle and configured to receive a ball mount in a stowed position therein, the storage device comprising:
a storage receptacle defining an inner cavity configured to receive a portion of the ball mount therein, the storage receptacle having opposite side walls, a top wall, a bottom wall, and an aperture formed in each of the opposite side walls, and
a mount coupled to the top wall of the receptacle and configured to engage the receiver.

2. The storage device of claim 1, wherein the longitudinal axis of the inner cavity of the storage receptacle is perpendicular to the longitudinal axis of an inner cavity of the receiver.

3. The storage device of claim 1, wherein the mount includes first and second studs coupled to the top wall of the storage receptacle in spaced-apart relationship to one another and an upper plate removably coupled to each of the first and second studs.

4. The storage device of claim 3, wherein the mount includes a U-shaped bolt coupled to the top wall of the storage receptacle, and wherein the U-shaped bolt includes the first and second studs.

5. The storage device of claim 1, wherein the mount includes first and second flanges coupled to the top wall of the storage receptacle in spaced-apart relationship to one another and a top wall coupled to each of the first and second flanges to define an aperture configured to receive the receiver therethrough.

6. A storage device configured to be coupled to a receiver of a tow vehicle and configured to receive a ball mount in a stowed position therein, the storage device comprising:
a generally square-shaped tube defining an inner cavity configured to receive a portion of the ball mount therein, wherein the longitudinal axis of the inner cavity of the tube is perpendicular to the longitudinal axis of an inner cavity of the receiver, and
a mount coupled to a top wall of the tube and configured to be removably coupled to the receiver.

7. A method of storing a ball mount in a stowed position on a tow vehicle, the method comprising:
coupling a generally square-shaped tube to a receiver of the tow vehicle,
positioning the tube below the receiver such that the longitudinal axis of the tube is generally perpendicular to the longitudinal axis of the receiver,
inserting a portion of the ball mount within the tube, and
locking the ball mount to the tube.
